(19) United States
(12) Patent Application Publication
(10) Pub. No.: US 2003/0030861 A1
(43) Pub. Date: Feb. 13, 2003

(54) Methods for reliable communication of link monitoring information in optical communications networks

(76) Inventors: John Mellert, Baltimore, MD (US); Ronald E. Johnson, Pasadena, MD (US); Jeffrey Lynch, College Park, MD (US)

Correspondence Address: Johnny A. Kumar, FOLEY & LARDNER, Washington Harbour, 3000 K Street, N.W., Suite 500, Washington, DC, 20007-5109, US

(21) Appl. No.: 09/927,441

(22) Filed: Aug. 13, 2001

(51) Int. Cl. H04B 10/08; H04J 14/02

(52) U.S. Cl. 359/110; 359/124

(57) ABSTRACT

Link monitoring architectures and methods that provide high reliability supervisory signaling in optical communication systems are described. Supervisory signals are transmitted via a communications channel, e.g., using overmodulation of an optical data signal envelope, between terminal units and line units in optical communication systems. The line units can be organized in groups of fiber pairs which share pump lasers and control units for handling the supervisory signaling. According to one exemplary embodiment, a line unit assembly includes two fiber pairs which have four control units which redundantly perform operations based upon commands received from the terminal units.

### RELATED APPLICATION

This application is related to U.S. Patent Application Serial No. ______ , entitled “Redundant Line Unit Monitoring Architecture”, to Mellert et al., filed on an even date herewith, the disclosure of which is incorporated by reference.

### FIELD OF INVENTION

This invention relates generally to optical communications networks and, more particularly, to methods and systems for monitoring and controlling optical communication networks and components thereof.

### BACKGROUND OF THE INVENTION

From the advent of the telephone, people and businesses have craved communication technology and its ability to transport information in various formats, e.g., voice, image, etc., over long distances. Typical of innovations in communication technology, recent developments have provided enhanced communications capabilities in terms of the speed at which data can be transferred, as well as the overall amount of data being transferred. As these capabilities improve, new content delivery vehicles, e.g., the Internet, wireless telephony, etc., drive the provision of new services, e.g., purchasing items remotely over the Internet, receiving stock quotes using wireless short messaging service (SMS) capabilities etc., which in turn fuels demand for additional communications capabilities and innovation.

Recently, optical communications have come to the forefront as a next generation communication technology. Advances in optical fibers over which optical data signals can be transmitted, as well as techniques for efficiently using the bandwidth available on such fibers, such as wavelength division multiplexing (WDM), have resulted in optical technologies being the technology of choice for state-of-the-art long haul communication systems.

For long haul optical communications, the optical signal must be periodically amplified to compensate for the tendency of the data signal to attenuate. For example, in the exemplary submarine optical communication system shown in FIG. 1, the terrestrial signal 10 is processed in WDM terminal 12 for transmission via optical fiber 14. Periodically, e.g., every 75 km, a line unit 16 amplifies the transmitted signal so that it arrives at WDM terminal 18 with sufficient signal strength (and quality) to be successfully transformed back into a terrestrial signal. Erbium-doped fiber amplifiers (EDFAs) have conventionally been used for amplification in these types of systems. EDFAs employ a length of erbium-doped fiber in conjunction with a pump laser that injects a pumping signal having a wavelength of, for example, approximately 1480 nm. This pumping signal interacts with the f-shell of the erbium atoms to stimulate energy emissions that amplify an optical signal having a wavelength of about 1550 nm. One drawback of EDFA amplification techniques is the relatively narrow bandwidth within which amplification occurs, i.e., the so-called erbium spectrum. Future generation systems will likely require wider bandwidths than that available from EDFA amplification in order to increase the number of channels (wavelengths) available on each fiber, thereby increasing system capacity.

Raman amplification is one amplification scheme that can provide a broad and relatively flat gain profile over a wider wavelength range than that which has conventionally been used in optical communication systems employing EDFA amplification techniques. Raman amplifiers employ a phenomenon known as “stimulated Raman scattering” to amplify the transmitted optical signal. In stimulated Raman scattering, radiation from a pump radiation source interacts with a gain medium through which the optical transmission signal passes to transfer power to that optical transmission signal. One of the benefits of Raman amplification is that the gain medium can be the optical fiber itself, i.e., no specially doped fiber is required as in EDFA techniques. For example, Raman amplification can be performed by coupling a pump laser, which generates a light beam having a predetermined wavelength, at points along the optical fiber. The wavelength of the pump laser is selected such that the vibration energy generated by the pump laser beam's interaction with the gain medium, e.g., the optical fiber itself, is transferred to the transmitted optical signal in a particular wavelength range. This wavelength range establishes the gain profile of the pump laser. However, the typical gain profile of 20-30 nm for a single wavelength pump laser is too narrow to support the wide bandwidths of, e.g., 100 nm or more, that are desired for next generation optical communication systems. To broaden the gain profile, Raman amplifiers can use multiple pump lasers for generating pump laser wavelengths over a broad wavelength range. The individual gain profiles attributable to each pump laser sum to provide a combined gain profile that can be used to amplify a transmitted optical signal over a much wider bandwidth.

In addition to providing amplification across a relatively wide bandwidth, it is also desirable that the combined gain profile be as flat as possible so that the amplification provided by each line unit is uniform, i.e., each channel receives substantially the same amount of amplification. Providing a flat combined gain profile for a number of pump lasers is further complicated by the fact that the Raman gain varies as a function of pump power and pump wavelength. Thus, the pump power of each laser should be individually designed and controlled in an optical communication system employing Raman amplification.

Although the ability to amplify an optical signal over a wide bandwidth makes Raman amplification an attractive option for next generation optical communication systems, the use of a relatively large number of potentially expensive pump lasers for each amplifier in the system makes such systems more complex in certain respects than existing systems that employ EDFA technology. For example, the powers and wavelengths of the pump lasers for each amplifier in the system should be carefully designed and maintained in order to ensure that a flat gain profile is maintained. Moreover, considering that some optical communication systems, e.g., submarine systems, are particularly difficult to repair, it would further be desirable to design such systems with sufficient redundancy that communications service can be maintained even if one or more pump lasers, or other components, fail over time. These factors make the implementation of a supervisory system, which permits the exchange of control information between the terminal units and the line units, an important aspect of next generation optical communication systems.

Conventional optical communication systems have included supervisory systems. For example, the article entitled “A Remote Supervisory System Based on Subcarrier Overmodulation for Submarine Optical Amplifier Systems”, to Murakami et al., Journal of Lightwave Technology, Vol. 14, No. 5, May 1996, the disclosure of which is incorporated here by reference, describes a supervisory system which overmodulates the line signal with supervisory information, e.g., instructions to change the pump laser bias current limit or to sample repeater state information. This technique permits the terminal devices to communicate control information with the line units. However, such conventional monitoring systems lack redundancy within the monitoring architecture, which renders them unsatisfactorily susceptible to failure.

Accordingly, there remains a need for monitoring and control systems that will monitor the operation of long haul optical communication systems in a reliable manner that employs redundancy in the monitoring architecture.

### BRIEF SUMMARY OF THE INVENTION

These, and other, drawbacks, limitations and problems associated with conventional optical communication systems are overcome by exemplary embodiments of the present invention, wherein high reliability communication between terminals and line units is provided using redundant processing elements and communication paths. Exemplary monitoring and control systems according to the present invention provide the capability for the terminals and line units to exchange maintenance and control information over a communication channel. If the communication channel should fail, e.g., due to a fiber cut or failure in a monitoring component, the system can use a redundant channel, fiber or component to preserve the monitoring and control capabilities of the system.

According to these exemplary embodiments, the communication channel for maintenance and control information can be implemented by modulation of the communication envelope within which the high data rate WDM channels are carried over the optical fiber. This modulation can be performed by varying the power of the pump lasers to transmit the desired maintenance/control information. Such information can, according to exemplary embodiments of the present invention, include parameters associated with the line unit such as the measured signal power of the transmitted optical signal, the measured power(s) of one or more of the pump lasers and settings for pump power or current.

Reliability of such communications is enhanced through the use of redundant components. For example, a set (e.g., two, four, eight, etc.) of optical fibers can share pump lasers and monitoring components. According to one such exemplary embodiment, a line unit, connected to at least a first optical fiber and a second optical fiber, includes a first line assembly having a first monitoring receiver, coupled to the first optical fiber, for receiving control information associated with a first optical signal transmitted over the first optical fiber; and at least one first pump laser, coupled to the first optical fiber. The line unit also includes a second line assembly having a second monitoring receiver coupled to the second optical fiber; and at least one second pump laser, coupled to the second optical fiber. The first and second monitoring receivers are connected to each other such that the control information is sent from the first monitoring receiver to the second monitoring receiver.

The present invention uses such redundant architecture to perform reliable transmissions of control information between line units and terminal units in optical communication systems. For example, a group of devices, e.g., pump lasers, are provided in the line unit which and are controlled based on the control information. Each of the groups of devices are connected to at least two control units in the line units, each of which can process the control information to control the group of devices. The control information is transmitted by a terminal to a selected one of the at least two control units. The terminal can select the control unit to which the control information is transmitted based upon, among other things, the operational status of the relevant control units.

### BRIEF DESCRIPTION OF THE DRAWINGS

FIG. 1 is a schematic diagram of an optical communication system in which the present invention can be implemented;

FIG. 2 is a block diagram of an exemplary terminal unit of an optical communication system including link monitoring equipment according to exemplary embodiments of the present invention;

FIG. 3 is a block diagram depicting the link monitoring equipment of FIG. 2 in somewhat more detail;

FIG. 4 is a block diagram of an exemplary line unit of an optical communication system including link monitoring equipment according to an exemplary embodiment of the present invention;

FIG. 5 is a block diagram of an exemplary line unit of an optical communication system including link monitoring equipment according to another exemplary embodiment of the present invention;

FIG. 6 is a block diagram similar to that of FIG. 5 with certain interconnections omitted for clarity; and

FIG. 7 is a flowchart depicting an exemplary method for controlling a line unit using the architecture of FIG. 6 according to the present invention.

### DESCRIPTION OF PREFERRED EMBODIMENTS

In the following description, for the purposes of explanation and not limitation, specific details are set forth, such as particular systems, networks, software, components, techniques, etc., in order to provide a thorough understanding of the present invention. However, it will be apparent to one skilled in the art that the present invention may be practiced in other embodiments that depart from these specific details. In other instances, detailed descriptions of known methods, devices and circuits are abbreviated or omitted so as not to obscure the present invention.

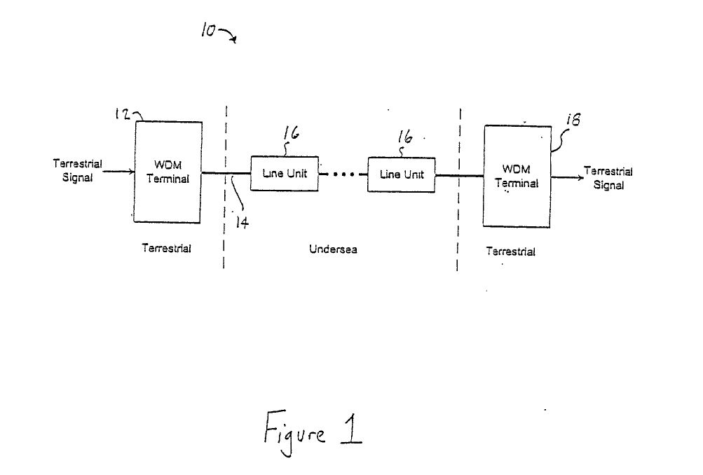

Link monitoring techniques and systems according to exemplary embodiments of the present invention involve communication of maintenance and control information between the terminals 12 and 18 and the line units 16 of communication systems such as those depicted in FIG. 1. This information can include, for example, measured optical data signal power, measured pump power and settings for pump power/current and commands from the terminal to one or more line units to perform measurements or set pump current. Those skilled in the art will appreciate that other information and/or commands may also be communicated between line units and terminals than the examples provided herein.

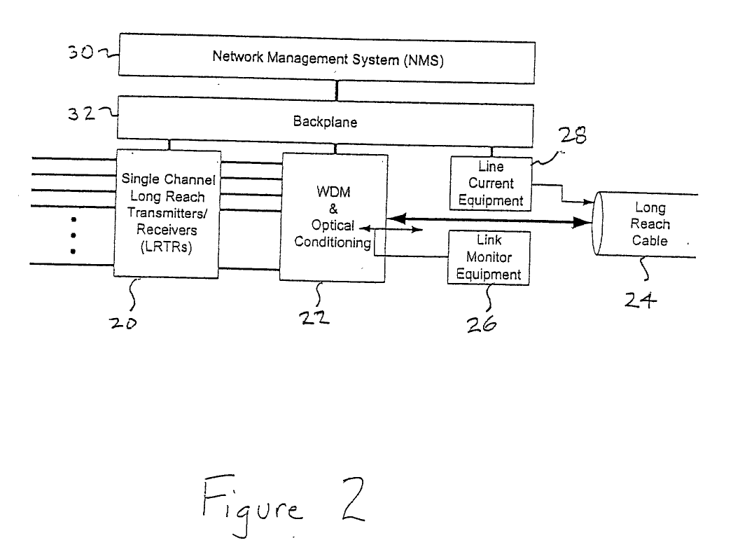

An exemplary architecture for terminal 12 and 18 is provided in the block diagram of FIG. 2. Therein, the long reach transmitters/receivers (LRTRs) 20 convert terrestrial signals into an optical format for long haul transmission, convert the undersea optical signal back into its original terrestrial format and provide forward error correction. The WDM and optical conditioning unit 22 multiplexes and amplifies the optical signals in preparation for their transmission over cable 24 and, in the opposite direction, demultiplexes optical signals received from cable 24. The link monitor equipment 26, described in more detail below, monitors the undersea optical signals and undersea equipment for proper operation. The line current equipment 28 provides power to the undersea line units 16. The network management system (NMS) 30 controls the operation of the other components in the WDM terminal, as well as sending commands to the line units 16 via the link monitor equipment 26, and is connected to the other components in the WDM terminal via backplane 32.

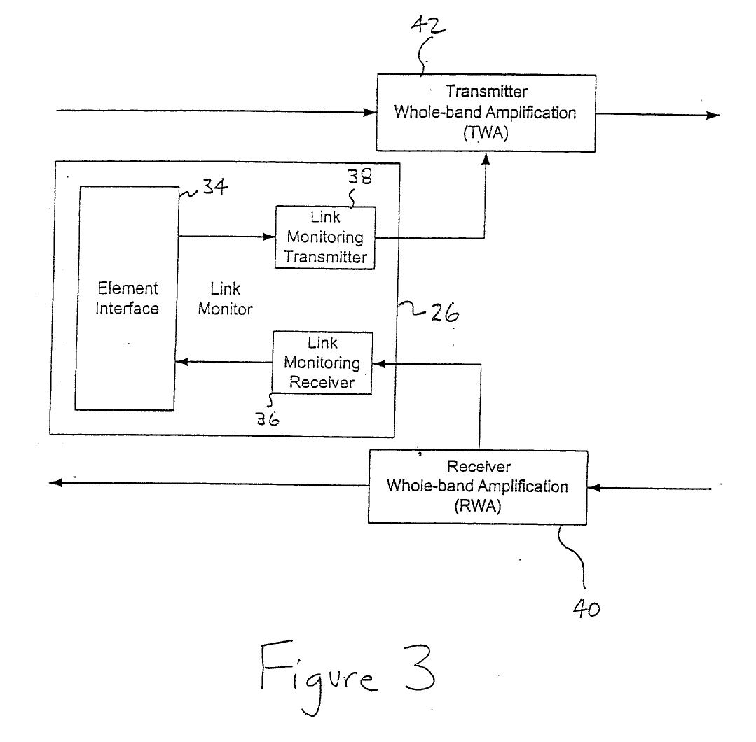

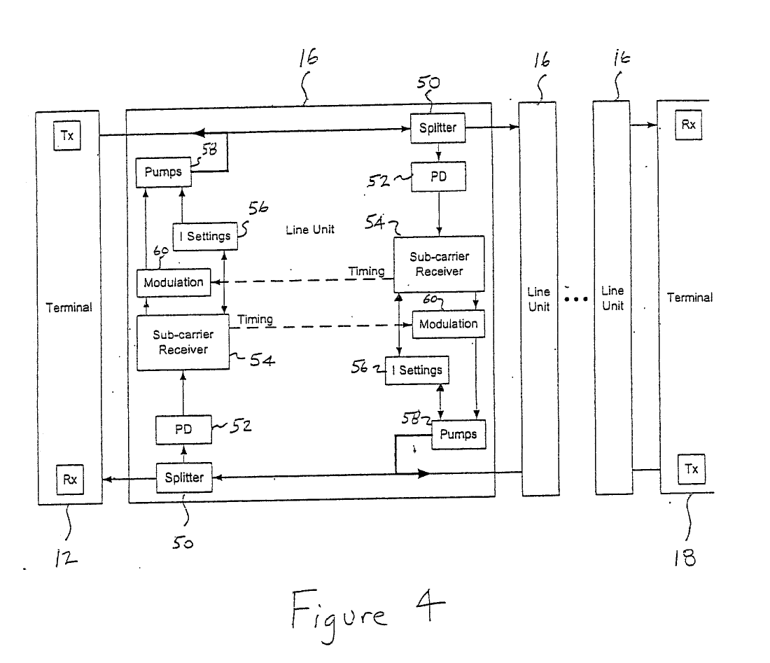

FIG. 3 depicts the link monitor equipment 26 of FIG. 2 in more detail. Therein, the NMS 30 interfaces with the link monitor equipment 26 via element interface 34. The link monitor equipment 26 also includes a link monitoring receiver 36 and a link monitoring transmitter 38. The link monitoring receiver 36 uses a splitter and a photodetector (not shown in FIG. 3, see, e.g., FIG. 4) to access the subcarrier monitoring signal from the receiver whole band amplification unit 40, which monitoring signal has been modulated onto the envelope of the WDM data signal by one or more line units 16. This information, e.g., regarding measurements of data signal power and/or pump power made by the line units, is then passed on to NMS 30 via the element interface 34. Likewise, the link monitoring transmitter 38 is controlled by the element interface 34 to modulate commands onto the envelope of a WDM data signal using the laser pump assembly (not shown) of the transmitter whole band amplification unit 42. Each command can comprise an address for the line unit(s) 16 which is the intended recipient of the command, as well as an opcode that defines the operation to be performed by the addressed line unit, e.g., measure pump power, measure optical data signal power, etc. Although FIG. 3 only illustrates a single set of link monitoring transmitters and receivers, those skilled in the art will appreciate that additional sets of such equipment will be provided in each terminal, e.g., a set associated with each fiber pair, such that each supervisory information can be transmitted to each line unit 16 via a number of different paths.

Exemplary link monitoring circuitry according to the present invention is also depicted in FIG. 4 in the context of one of the line units 16. Therein, each fiber has a splitter 50 connected thereto to sample part of the traveling WDM data signal. The splitters 50 can, for example, be implemented as 2% couplers. A photodetector 52 receives the sampled optical signal from its respective splitter 50 and transforms the optical signal into a corresponding electrical signal. The photodetector 52 outputs the electrical signal to a corresponding sub-carrier receiver unit 54, which detects and decodes the commands present in the sub-carrier modulated monitoring signal that has been modulated on the envelope of the WDM data signal. After decoding the command, the particular sub-carrier receiver 54 determines whether the decoded command is intended for it. If so, the action in the command is executed, e.g., measuring the power of the WDM signal, measuring the pump power output from one or more lasers in the pump assembly, or changing the supply current to the lasers of the pump assembly. To this end, the sub-carrier receivers 54 are connected to respective current control and power monitoring units (I settings) 56, which each include pump power monitors and pump current controls for each laser in the associated pump laser assembly 58.

If measurements are requested by the NMS 30, then the sub-carrier receiver 54 provides the requested measurement information to its respective modulation unit 60. The modulation unit 60 adjusts the bias current for one or more of the lasers associated with pump laser assembly 58 such that the envelope of the high rate data signal is modulated to include the measurements, or other information, requested by the NMS. The requested measurement information is then returned to NMS 30 for evaluation and the process continues.

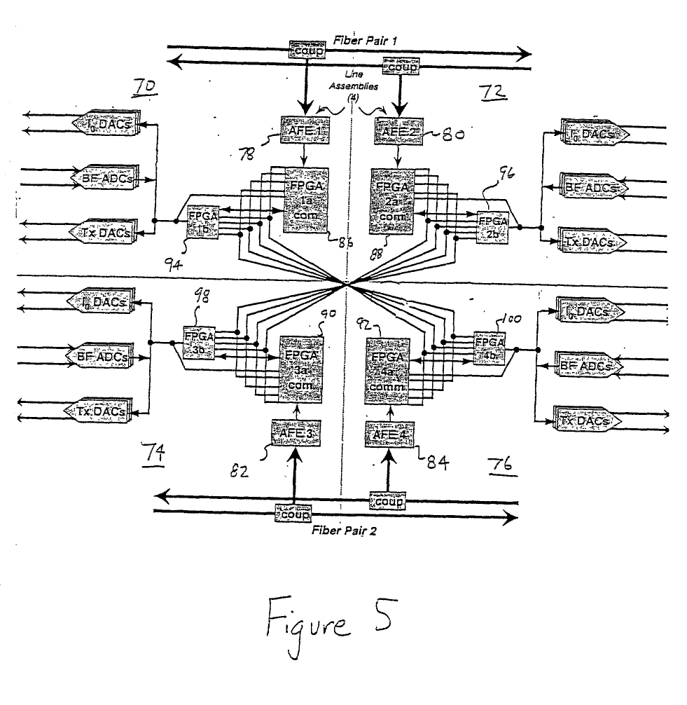

According to exemplary embodiments of the present invention, the line unit 16 may have an architecture which is based upon the sharing of pump lasers among two fiber pairs, i.e., four optical fibers, two fibers carrying optical data signals in each direction between the terminals 12 and 18. In such exemplary embodiments, the monitoring and control architecture described above can be implemented with additional redundancy, e.g., commands from the terminals to any given line unit can be transmitted over one of four fibers and a number of sub-carrier receivers can be redundantly employed in each line unit as seen in the example depicted in FIG. 5.

Therein, the monitoring architecture associated with a line unit 16 (or portion of a line unit 16 if more than two fiber pairs are used in the system) is depicted in terms of four line assemblies 72-76. In general, each line assembly includes a monitoring receiver, at least one pump laser and associated circuitry, e.g., digital-to-analog converters (DACs), analog-to-digital converters (ADCs), and communication buses or other communication interconnects which connect the monitoring receivers to one another. The monitoring receivers each include an analog front end 78-84 which demodulates the control information associated with the optical data signal which has been transmitted over the optical fiber to which it is coupled, e.g., via a 2% coupler. For the purposes of the present invention, the details of the modulation techniques, channelization techniques, etc. associated with communicating the supervisory information in conjunction with the optical data signal are not significant as any and all such techniques are contemplated herein. The interested reader is referred to the above-incorporated by reference article for an example of one technique by way of which such control information can be conveyed to the monitoring architecture described herein, although the present invention is not limited thereto.

Each monitoring receiver also has a primary control unit 86-92 connected to a respective AFE 78-80 for receiving and operating on the commands within the demodulated control information. In accordance with one exemplary usage of this architecture according to the present invention, all of the control information directed to a particular line unit 16 is directed to one AFE/primary control unit pair at any given time, with the remaining AFE/primary control unit pairs being redundant, as will be described below. Each line assembly also includes a secondary control unit, e.g., labeled 94, 96, 98 and 100 in FIG. 5. Both the primary and secondary control units are, in this example, implemented as field programmable gate arrays (FPGAs). However, either or both control units could also be implemented using other devices, e.g., digital signal processors (DSPs). In this example, each line assembly 70, 72, 74 and 76 has eight laser diode pairs (not shown) which are monitored and controlled thereby. However, those skilled in the art will appreciate that any number of pump lasers can be monitored and controlled in accordance with the present invention.

As seen in FIG. 5, all of the primary and secondary control units are interconnected, e.g., via a communications bus or any other desired communications interconnect. This interconnect can take any desired form, e.g., each primary and secondary unit can be directly connected to one another (thereby minimizing the need to perform routing of the control information) or a ring interconnect can be used. This permits control information to be shared among the control units and provides quad redundancy for supervisory communications between terminals and line units in optical communication systems according to the present invention. More specifically, by implementing monitoring architectures according to this exemplary embodiment of the present invention, there are four optical fibers and four monitoring receivers over which control commands can be sent to adjust or monitor the current or power of any of the pump lasers within the line unit 16. Additionally, there is dual redundancy within each line assembly 70, 72, 74 and 76 by virtue of providing both a primary and secondary control unit per line assembly. Accordingly, failure of any one control unit within a line assembly or any three communication paths to the ring of control units will not impair supervisory communications with a line unit, thereby providing significant reliability benefits to this aspect of optical communication systems and line units which operate in accordance with the present invention.

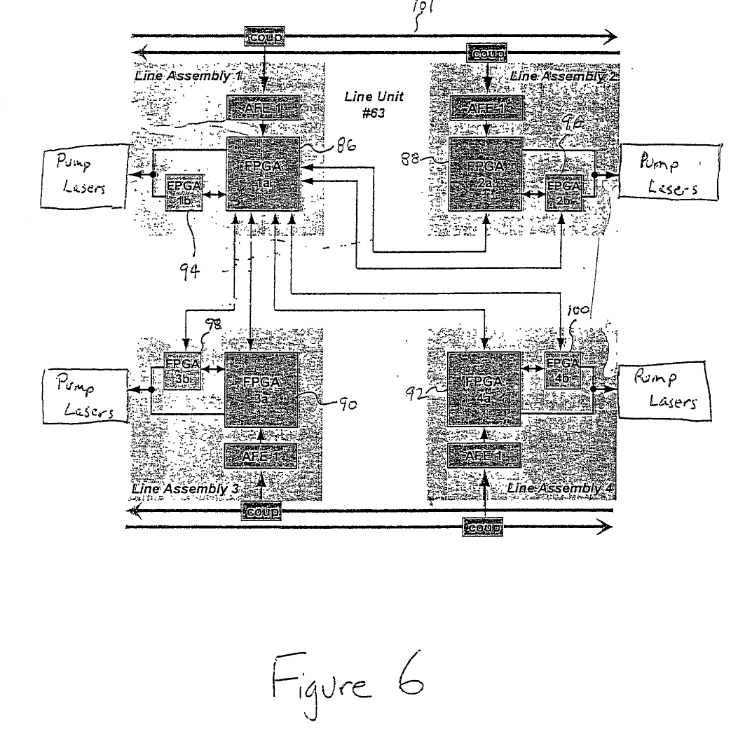

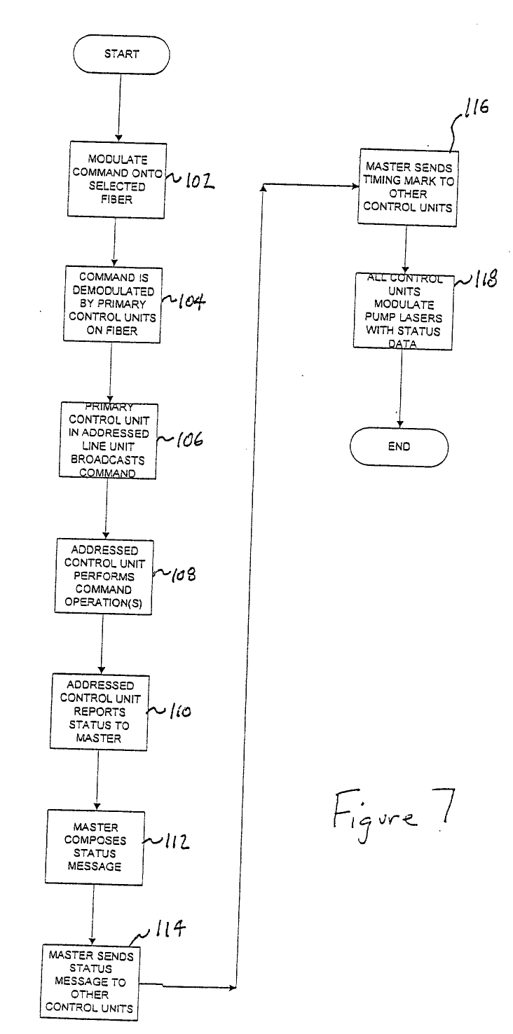

To further illustrate the operation of such architectures in accordance with the present invention, a specific example of supervisory communications will now be provided in reference to FIGS. 6 and 7. In FIG. 6, a similar architecture to that depicted in FIG. 5 is provided, and the same reference numerals are used to denote the same structures, with the exception that some of the interconnectivity between the control units has been omitted to simplify the schematic. FIG. 7 is a flowchart within which an exemplary communication process according to the present invention is illustrated, which process can be performed using the structure depicted in FIG. 6. Therein, at step 102, one of the terminals 12 or 18 transmits a command having the address for the line unit of FIG. 6, e.g., 63 or binary 111111. The format of control commands is, like the selection of modulation and channelization, not particularly significant for the purposes of the present invention and any format is contemplated hereby. However, for the sake of this example, consider that the control command transmitted by a terminal includes at least one address of the line unit(s) that are the intended recipients of the command, at least one opcode that defines the type of operation to be performed by the addressed command, and one or more additional values or operands which indicate the manner in which the command shall be implemented by the line unit. The address field can be a composite of a line unit address and a control unit address, the latter of which specifies which control unit within the line unit is responsible for acting on the command.

The terminal 12 or 18 shall select the fiber on which to modulate the command, in this example fiber 101, at step 102. For example, one fiber can be designated as a default fiber for transmitting commands. Alternatively, any other desired selection technique can be employed. The command is received and demodulated by all of the line units 16 in the system, however only the addressed line unit, in this example line unit #63, will react thereto. More specifically, since the command was modulated onto the envelope of the optical data signal propagating along fiber 101, the primary control unit 86 in the first line assembly will receive the command. The primary control unit 86 compares the line unit address within the command to its own line unit address at step 104. When a match occurs, the command is forwarded to all of the active control units in the quad line unit assembly, with primary control unit 86 becoming the master control unit for the supervisory session which is initiated by the receipt of this command at step 106. Since each line assembly includes two control units, in this exemplary embodiment, only one of them need be active at any given time. Thus, for this example, master control unit 86 can broadcast the received command to the secondary control units 96, 98, 100 or the primary control units 88, 90 and 92, or any other combination of the control units associated with the other line assemblies. The designation of a control unit within a line unit as active or inactive is performed by the NMS as will be described below.

The active control units then evaluate the portion of the address (subaddress) that identifies the control unit which is the intended recipient of the command within the line unit 16. For this example, consider that the command is directed to line assembly 3 to set the bias currents on its pump laser pair number 8. Thus, the active control unit (either primary control unit 90 or secondary control unit 98) within that line assembly will receive, decode and perform the command operation, in this example setting the bias currents on one of the pump laser pairs under its control at step 108. The active control unit can also gather information, e.g., measurements, regarding the pump lasers under its control. For this example, the active control unit 90 or 98 reads the back facet (BF) currents (see FIG. 5) of the #8 pump laser pair to generate feedback on the results of the command operation. This feedback is reported to the master control unit 86 at step 110, which then composes a status message for the NMS at step 112. The status message can, for example, provide an indication that the command operation was successfully performed or can provide more specific details regarding the results, e.g., the back facet readings of the adjusted pump laser pair. The master control unit 86 then broadcasts the status message to the other active control units at step 114. A timing mark is (optionally) sent to the active control units as step 116, which step can be omitted if some other mechanism is employed for synchronizing the transmission of control information by the various control units or if synchronization is not required. Next, at step 118, all four active control units begin modulating their respective pump lasers with the same, status message data. This will transmit the status message along all four fibers to the terminals 12 and 18 with dual redundancy. Alternatively, the status message could be supplied to a subset of the active control units for transmission on fewer than all of the fibers associated with this quad line assembly.

It will be apparent to those skilled in the art that link monitoring methods and systems according to the present invention provide enhanced reliability to the communication of monitoring and control information for optical communication systems, e.g., submarine systems. Such redundancy can be employed in a number of different ways to promote reliability. For example, suppose that either of primary control unit 86, AFE 78 or fiber 101 associated with line unit 63 failed at some point during its operational life span, such that control information could not be communicated with the quad line assembly in the line unit of FIG. 6 via that communication path. This fact would become apparent to the NMS 30, e.g., after a timer timed out for failure to receive a response to one or more commands, which could then designate primary control unit 88 as the recipient of subsequent commands to be sent to that particular line unit. At the same time, secondary control unit 94 could be designated as active for line assembly 70, while secondary control unit 96 could be designated as inactive for line assembly 72 (if not so designated already). In this way, supervisory communication with the line assemblies 70, 72, 74 and 76 is maintained despite the failure and without the need to repair the line unit by switching the communication path to the line unit (or portion thereof) when a predetermined fault condition is detected.

Moreover, the dual redundancy provided by the primary and secondary control units in each line assembly according to these exemplary embodiments can also be exploited to provide robustness in control communication methods according to the present invention. Using the example described above with respect to FIGS. 6 and 7, when the terminal unit 12 or 18 determines that an adjustment to the bias current of pump laser pair #8, it composes a command to the line unit 16 which includes, for example, various fields including an address of one of the two control units (either primary control unit 90 or secondary control unit 98) that can control that particular laser pair. The selection of which control unit within the line unit assembly should be addressed will be made based upon the terminal (NMS)'s knowledge of the operational status of the two control units. Should an active one of the two control units become inoperative, the terminal (NMS) will transmit subsequent control commands associated with that line unit assembly using the address of the other control unit.

The present invention is not limited to the transmission of supervisory information using overmodulation of the optical data signal. As an alternative, one of the wavelength channels (or a portion of a channel) can be reserved for use as the supervisory channel.

Certain exemplary embodiments have been set forth herein for the purpose of illustration. However, these embodiments are intended, in all respects, to be illustrative rather than limitive, of the present invention. For example, the present invention is amenable to implementation in any type of optical communication system using any type of amplification technique, e.g., those employing EDFA amplification, distributed Raman amplification or hybrids thereof. Accordingly, various modifications, adaptations, and alternatives may occur to one skilled in the art without departing from the scope of the claimed inventive concept.

What we claim is:

1. A method for communicating control information between a line unit and a terminal unit in an optical communication system comprising the steps of:
transmitting, from said terminal, said control information on a selected optical fiber;
receiving and decoding at least some of said control information at a first control unit of said line unit; and
sending said control information from said first control unit to a second control unit within said line unit, whereupon said second control unit decodes said control information and performs a command based on said control information.

2. The method of claim 1, wherein said control information is a command to measure a power associated with a pump laser in said line unit.

3. The method of claim 1, wherein said control information is a command to adjust a current associated with a pump laser in said line unit.

4. The method of claim 1, wherein said control information is a command to measure a signal strength associated with a wavelength division multiplexed data signal at said line unit.

5. The method of claim 1, further comprising the steps of: demodulating, at said line unit, said control information from an envelope of a wavelength division multiplexed data signal; and performing a command associated with said control information.

6. The method of claim 1, further comprising the steps of:
decoding, at said first control unit, at least a portion of an address associated with said control information; and
broadcasting said control information to a plurality of additional control units within said line unit, said plurality of additional control units including said second control unit.

7. A method for reliably transmitting control information between a line unit and a terminal unit in an optical communication system comprising the steps of:
providing a plurality of communication paths between said line unit and said terminal unit;
selecting one of said plurality of communication paths between said line unit and said terminal unit for use in transmitting said control information;
transmitting said control information using said selected path until a predetermined fault characteristic is detected; and
selecting another of said plurality of communication paths for transmitting said control information after said predetermined fault characteristic is detected.

8. The method of claim 7, wherein each of said plurality of communication paths includes a different optical fiber.

9. The method of claim 7, wherein each of said plurality of communication paths includes a receiver unit for demodulating said control information.

10. The method of claim 7, wherein each of said plurality of control paths includes at least one control unit for decoding said control information and selectively performing an operation associated therewith.

11. The method of claim 10, wherein each of said plurality of control paths includes two control units for decoding said control information and selectively performing said operation associated therewith.

12. The method of claim 11, wherein said two control units are individually addressable by said terminal unit.

13. The method of claim 10, wherein said operation involves setting a bias current associated with at least one pump laser.

14. A method for reliably transmitting control information between a line unit and a terminal unit in an optical communication system comprising the steps of:
providing a group of devices in said line unit which are controlled based on said control information;
providing at least two control units in said line unit, each of which are connected to said group of devices and each of which can process said control information to control said group of devices; and
transmitting said control information, by said terminal, to a selected one of said at least two control units, wherein said selection of said one of said at least two control units is based upon an operational status thereof.

15. The method of claim 14, wherein said group of devices is a group of pump lasers which pump an optical data signal transmitted between said terminal unit and said line unit.

16. The method of claim 14, wherein said line unit further comprises a plurality of said group of devices and a corresponding plurality of said at least two control units, said method further comprising the step of:
addressing, by said terminal, a command to control a particular device within one of said groups of devices to a corresponding one of said at least two control units.

17. The method of claim 16, further comprising the step of: receiving said addressed command by a control unit within said line unit which is different than said corresponding one of said at least two control units and forwarding said addressed command thereto.
